(19) United States
(12) Patent Application Publication
(10) Pub. No.: US 2011/0128588 A1
(43) Pub. Date: Jun. 2, 2011

(54) Image forming apparatus and method for processing image noise using the same

(75) Inventors: Ki-Youn Lee, Suwon-si (KR); Yousun Bang, Seoul (KR)

(73) Assignee: SAMSUNG ELECTRONICS CO., LTD., Suwon-si (KR)

(21) Appl. No.: 12/801,783

(22) Filed: Jun. 24, 2010

(30) Foreign Application Priority Data
Dec. 2, 2009 (KR) 2009-0118574

(51) Int. Cl. G06T 5/00

(52) U.S. Cl. 358/3.27

(57) ABSTRACT

An image forming apparatus is provided. The image forming apparatus includes an output unit to output a density pattern, a detector to detect the output density pattern, a signal extraction unit to extract an image noise signal from at least two sensing areas of the detected density pattern, and a control unit to determine if image noise generated on the detected density pattern is one-dimensional noise or two-dimensional noise based on the extracted image noise signal.

### CROSS-REFERENCE TO RELATED APPLICATIONS

This application claims priority from Korean Patent Application No. 10-2009-0118574, filed on Dec. 2, 2009 in the Korean Intellectual Property Office, the disclosure of which is incorporated herein by reference in its entirety.

### BACKGROUND

1. Field

Embodiments described herein relate to an image forming apparatus and a method for processing image noise using the same, and more particularly, to an image forming apparatus capable of determining a type of image noise, and a method for processing image noise using the same.

2. Description of the Related Art

Image forming apparatuses are devices for generating, printing, receiving and transmitting image data. Image forming apparatuses include printers, scanners, copiers, facsimiles, and multifunction peripherals having functions of the aforementioned devices.

Recently, study of image quality improvement of an image output by an image forming apparatus has been extensive. In addition, study of image quality evaluation to objectively evaluate image quality improvement has been also made.

Although image quality of an image output by an image forming apparatus is improved, image noise may be caused due to fluctuation of mechanical components of the image forming apparatus.

Image noise includes one-dimensional noise and two-dimensional noise. However, conventional image forming apparatuses cannot distinguish one-dimensional noise and two-dimensional noise.

Therefore, there is a need for methods for distinguishing one-dimensional noise and two-dimensional noise so as to improve image quality of an image and objectively evaluate the improved image quality.

### SUMMARY

Reference will now be made in detail to example embodiments, examples of which are illustrated in the accompanying drawings, wherein like reference numerals refer to the like elements throughout. Example embodiments are explained by referring to the figures.

An aspect provides an image forming apparatus using at least two sensing areas, and a method for processing image noise using the same.

According to an embodiment, there is provided a method for processing image noise using an image forming apparatus, the method including outputting a density pattern, detecting the output density pattern, extracting an image noise signal from at least two sensing areas of the detected density pattern, and determining if image noise generated on the detected density pattern is one-dimensional noise or two-dimensional noise based on the extracted image noise signal.

In the determining, it may be determined if the image noise generated on the detected density pattern is one-dimensional noise or two-dimensional noise by determining a correlation coefficient between the extracted image noise signals is greater than a predetermined threshold value.

In the determining, it may be determined if the image noise generated on the detected density pattern is one-dimensional noise or two-dimensional noise by determining if multiplication between the extracted image noise signals is a specific value.

In the receiving, if the density pattern is output onto printing paper, the output density pattern may be detected by scanning the printing paper.

In the receiving, if the density pattern is output onto the intermediate transfer belt (ITB), the output density pattern may be received by detecting the density pattern on the ITB.

In the extracting, the image noise signal may be extracted at a particular position of each sensing area in one of a horizontal scanning direction and a vertical scanning direction.

The one-dimensional noise may be banding and the two-dimensional noise may be graininess or mottle.

The method may further include compensating the image noise according to the determined type of the image noise.

The method may further include outputting the determination results.

According to another embodiment, there is provided an image forming apparatus including an output unit to output a density pattern, a detector to detect the output density pattern, a signal extraction unit to extract an image noise signal from at least two sensing areas of the detected density pattern, and a control unit to determine if image noise generated on the detected density pattern is one-dimensional noise or two-dimensional noise based on the extracted image noise signal.

The control unit may determine if the image noise generated on the detected density pattern is one-dimensional noise or two-dimensional noise by determining a correlation coefficient between the extracted image noise signals is greater than a predetermined threshold value.

The control unit may determine if the image noise generated on the detected density pattern is one-dimensional noise or two-dimensional noise by determining if multiplication between the extracted image noise signals is a specific value.

If the density pattern is output onto printing paper, the detector may detect the output density pattern by scanning the printing paper.

If the density pattern is output onto the intermediate transfer belt (ITB), the detector may detect the output density pattern by detecting the density pattern on the ITB.

The signal extraction unit may extract the image noise signal at a particular position of each sensing area in one of a horizontal scanning direction and a vertical scanning direction.

The one-dimensional noise may be banding and the two-dimensional noise may be graininess or mottle.

The control unit may compensate the image noise according to the determined type of the image noise.

The image forming apparatus may further include a display unit to display the determination results.

According to another embodiment, there is provided an image forming apparatus including a printing engine unit to output a density pattern, a scanning unit to scan the output density pattern, a processor to extract an image noise signal from at least two sensing areas of the scanned density pattern, and determine if image noise generated on the scanned density pattern is one-dimensional noise or two-dimensional noise based on the extracted image noise signal, and a display unit to display a result of the determination.

### BRIEF DESCRIPTION OF THE DRAWINGS

The above and/or other aspects will be more apparent by describing certain exemplary embodiments with reference to the accompanying drawings, in which:

FIG. 1 is a schematic block diagram of an image forming apparatus according to an exemplary embodiment;

FIGS. 2A to 2C illustrate types of image noise;

FIGS. 3A and 3B illustrate density patterns according to the type of image noise;

FIG. 4 illustrates an example of a display unit;

FIG. 5 is a schematic block diagram of an image forming apparatus according to another embodiment; and

FIG. 6 illustrates a flow chart illustrating a method for processing image noise using the image forming apparatus according to an exemplary embodiment.

### DETAILED DESCRIPTION

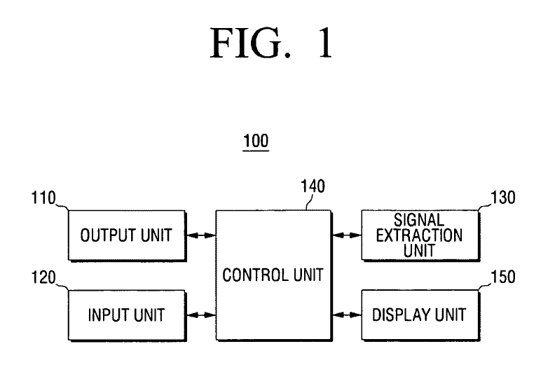

FIG. 1 is a schematic block diagram of an image forming apparatus 100 according to an exemplary embodiment. The image forming apparatus 100 may include an output unit 110, an input unit 120, a signal extraction unit 130, a control unit 140, and a display unit 150.

The output unit 110 outputs a density pattern. The density pattern may have the same size as printing paper, but it is possible that the density pattern has a size reduced to be smaller than printing paper. A density pattern may be a density pattern having one of cyan, magenta, yellow and black colors, and have a density value ranging from 0 to 255. A density pattern may not necessarily be a specific density value and may not necessarily have a uniform density distribution. If a density pattern has a non-uniform density distribution, it may be necessary to have information regarding the non-uniform density distribution.

The output unit 110 may output a density pattern directly onto printing paper of the image forming apparatus 100 or may output a density pattern onto an intermediate transfer belt (ITB) of the image forming apparatus 100.

In addition, if the control unit 140 determines if image noise is one-dimensional noise or two-dimensional noise, the output unit 110 outputs determination results directly onto printing paper.

The input unit 120 receives input of the output density pattern to detect the density pattern, and therefore, the input unit may also be referred to as a detector. The input unit 120 may detect the density pattern output onto printing paper using scanning of a scanning module (not shown). Alternatively, the input unit 120 may detect the density pattern output onto the ITB by sensing the density pattern on the ITB with a sensor module (not shown).

The signal extraction unit 130 extracts an image noise signal from at least two sensing areas of the detected density pattern. For each sensing area, a sensor may be provided. More specifically, in a density pattern which has pixels set to have specific density values, if there are pixels which have density values which are different from the set density values, the signal extraction unit 130 regards such pixels as image noise signals and outputs the image noise signals. The image noise may be noise which is caused due to fluctuation of components or function modules in the image forming apparatus 100.

The signal extraction unit 130 may include at least two sensors. The signal extraction unit 130 may extract an image noise signal at a particular position of each sensing area in one of the horizontal scanning direction and the vertical scanning direction.

The control unit 140 performs the overall control operation.

More specifically, the control unit 140 determines a type of image noise generated on the detected density pattern based on the extracted image noise signal. That is, the control unit 140 determines if the image noise is one-dimensional noise or two-dimensional noise.

In addition, the control unit 140 compensates the image noise according to the determined type of image noise.

If the control unit 140 determines if the image noise is one-dimensional noise or two-dimensional noise, the display unit 150 displays the determination results. The display unit 150 is provided on one area of the image forming apparatus 100, and for example, may be implemented as a liquid crystal display (LCD). The display unit 150 may include an operation panel. In addition, the display unit 150 may be implemented as a touch screen to receive a user command.

Since the image noise can be distinguished as one-dimensional noise or two-dimensional noise, image quality can be improved and image quality improvement can be objectively evaluated.

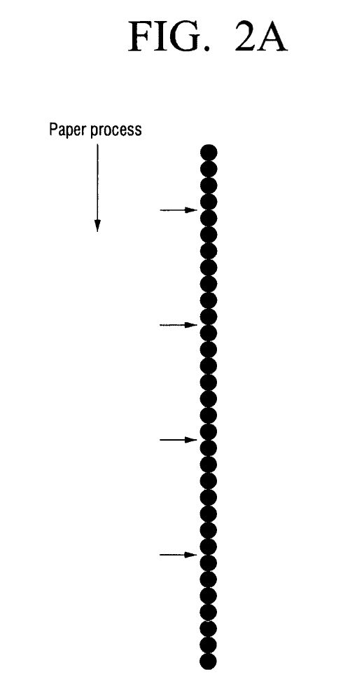

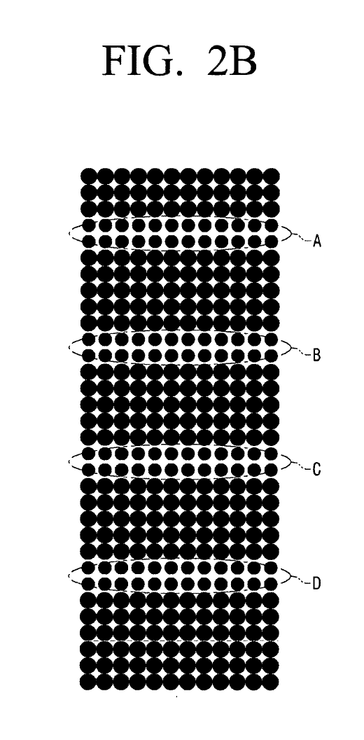

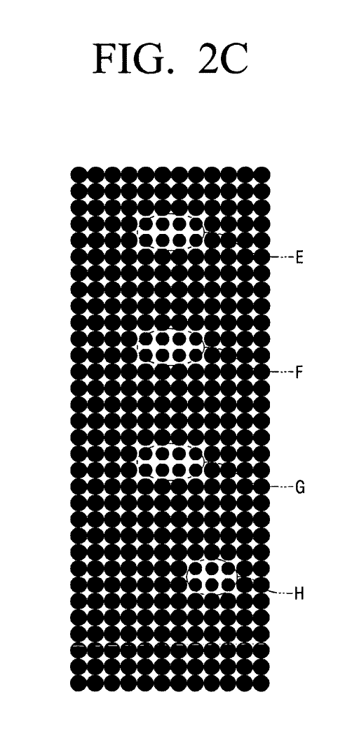

FIGS. 2A to 2C illustrate types of image noise. If printing paper is processed in the vertical scanning direction (vertically) as illustrated in FIG. 2A, FIG. 2B shows generation of one-dimensional noise, and FIG. 2C shows generation of two-dimensional noise.

In the one-dimensional noise shown in FIG. 2B, pixels (A, B, C and D) of the horizontal direction on a density pattern are disposed at regular intervals in the vertical scanning direction. Such one-dimensional noise may be banding.

For example, if the signal extraction unit 130 in which two sensing areas are set to be disposed vertically extracts an image noise signal, the signal extraction unit 130 extracts one-dimensional noise which is image noise having the same density values for the two sensing areas, that is, banding.

In the two-dimensional noise shown in FIG. 2C, some pixels (E, F, G and H) of the horizontal direction on a density pattern are disposed at regular intervals in the vertical scanning direction. Such two-dimensional noise may be graininess and mottle.

For example, if the signal extraction unit 130 in which two sensing areas are set to be disposed vertically extracts an image noise signal, the signal extraction unit 130 extracts two-dimensional noise which, contrary to the one-dimensional image noise, is image noise having different density values for the two sensing areas, that is, graininess and mottle.

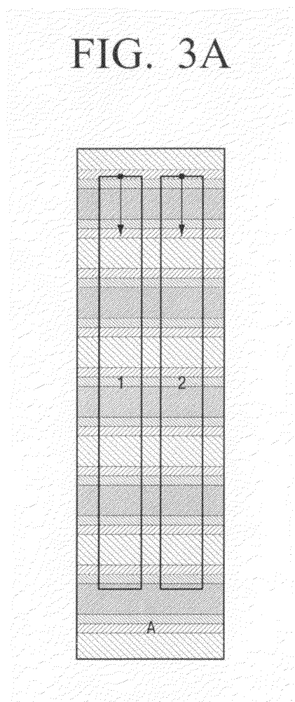

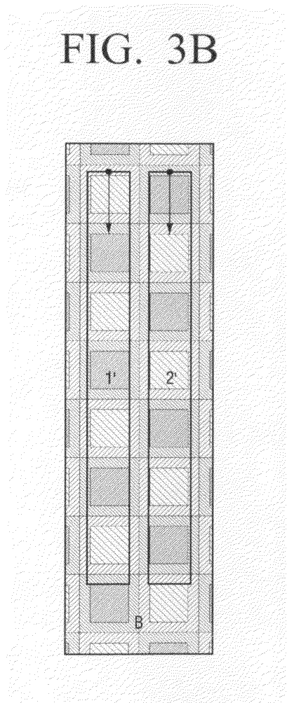

FIGS. 3A and 3B illustrate density patterns according to the type of image noise. The operation principle of the image forming apparatus 100 according to the exemplary embodiment is described in greater detail with reference to FIGS. 3A and 3B.

FIG. 3A illustrates a density pattern in which banding, which is one-dimensional noise, occurs, and FIG. 3B illustrates a density pattern in which graininess or mottle, which is two-dimensional noise, occurs. In FIGS. 3A and 3B, areas expressed in reference numerals 1, 2, 1′ and 2′ indicate sensing areas.

Referring to FIG. 3A, two sensors (a first sensor and a second sensor) start sensing from the centers of the upper ends of sensing areas 1 and 2 respectively. The two sensors start sensing from the same heights and move at the same speed. Accordingly, the first sensor of sensing area 1 and the second sensor of sensing area 2 have the same y-axis coordinates every time (it is assumed that the direction in which the sensors move is the y-axis).

In FIG. 3A, since sensing areas 1 and 2 have the same density values as described above, banding which is one-dimensional noise occurs. In FIG. 3B, since sensing areas 1′ and 2′ have different density values as described above, graininess or mottle which is two-dimensional noise occurs.

In FIGS. 3A and 3B, the number of sensing areas is 2, but the number of sensing areas may be 2 or more. In addition, an interval between the sensing areas is preset, but may vary by a user command. If an interval between the sensing areas varies, one-dimensional noise and two-dimensional noise may vary.

In one embodiment, the output unit 110 may be a printing engine module to output a density pattern directly onto printing paper, and the input unit 120 may be a scanning module to scan the printing paper.

In another embodiment, the output unit 110 may be a module to output a density pattern onto an ITB, and the input unit 120 may be a module to detect the density pattern output onto the ITB by sensing the density pattern on the ITB.

In these embodiments, the control unit 140 may determine if image noise is one-dimensional noise or two-dimensional noise by determining if a correlation coefficient between extracted image noise signals is greater than a predetermined threshold value.

More specifically, if banding which is one-dimensional noise occurs in a density pattern, left and right sensing areas have the same density values, so even if taking into consideration noise to some degree, a correlation coefficient between density values of pixels of the left and right sensing areas may be greater than the predetermined threshold value.

However, if graininess or mottle which is two-dimensional noise occurs in a density pattern, left and right sensing areas have different density values, so a correlation coefficient between density values of pixels of the left and right sensing areas may be lower than the predetermined threshold value.

In order to calculate the correlation coefficient, the Pearson correlation scheme may be used.

Alternatively, the control unit 140 may determine if image noise is one-dimensional noise or two-dimensional noise by determining if multiplication between extracted image noise signals is a specific value.

If banding which is one-dimensional noise occurs in a density pattern, left and right sensing areas have the same density values, so even if taking into consideration noise to some degree, multiplication of density values of pixels of the left and right sensing areas is a specific value.

However, if graininess or mottle which is two-dimensional noise occurs in a density pattern, left and right sensing areas have different density values, so a correlation coefficient between density values of pixels of the left and right sensing areas may be lower than the predetermined threshold value

Using the aforementioned methods, the control unit 140 can determine if the image noise generated on the detected density pattern is one-dimensional noise or two-dimensional noise.

The control unit 140 compensates image noise according to the type of image noise. More specifically, the control unit 140 compensates image noise by setting density values for pixels at which image noise is generated. In this case, the control unit 140 compensates image noise differently according to whether the image noise is one-dimensional noise or two-dimensional noise.

In the aforementioned embodiments, if the control unit 140 determines if image noise generated on the density pattern is one-dimensional noise or two-dimensional noise, the determination results may be output directly to the output unit 110 or may be displayed on the display unit 150.

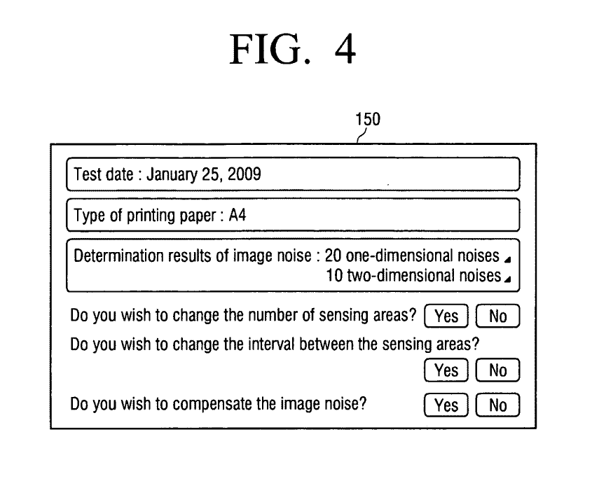

FIG. 4 illustrates an example of the display unit 150. Referring to FIG. 4, if the type of image noise is determined, the display unit 150 may display the test date, the type of printing paper, the determination results of image noise, an inquiry about whether to change the number of sensing areas, an inquiry about whether to change the interval between the sensing areas, and an inquiry about whether to compensate the image noise.

Referring to FIG. 4, twenty one-dimensional noises and ten two-dimensional noises are generated. The display unit 150 may show the position of image noise, which is not illustrated in FIG. 4, using coordinates of a pixel (a horizontal coordinate value x a vertical coordinate value). Accordingly, a user can identify the position of the image noise and the interval between the sensing areas.

Furthermore, the display unit 150 displays an inquiry about whether to change the number of sensing areas, an inquiry about whether to change the interval between the sensing areas, and an inquiry about whether to compensate the image noise. The display unit 150 which is implemented as a touch screen can receive responses to the inquiries from the user, and the control unit 140 performs operations corresponding to the user command.

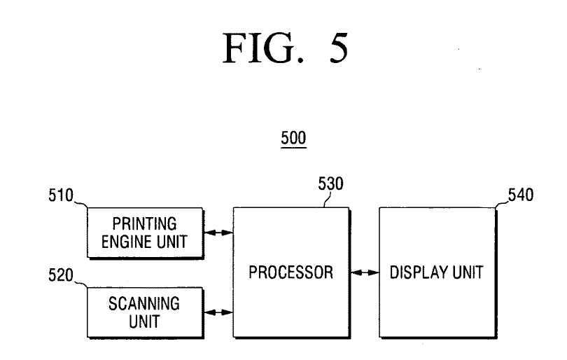

FIG. 5 is a schematic block diagram of an image forming apparatus according to another embodiment. Referring to FIG. 5, the image forming apparatus 500 may include a printing engine unit 510, a scanning unit 520, a processor 530, and a display unit 540.

The printing engine unit 510 outputs a density pattern. The scanning unit 520 scans the output density pattern. The processor 530 extracts an image noise signal from at least two sensing areas of the scanned density pattern, and determines if image noise generated in the scanned density pattern is one-dimensional noise or two-dimensional noise based on the extracted image noise signal. The display unit 540 displays the determination results of the processor 530.

Since the image noise can be distinguished as one-dimensional noise or two-dimensional noise, improved image quality can be evaluated objectively as well as improvement of image quality.

Description of FIG. 5 which overlaps with description of FIGS. 1 to 4 is not repeated.

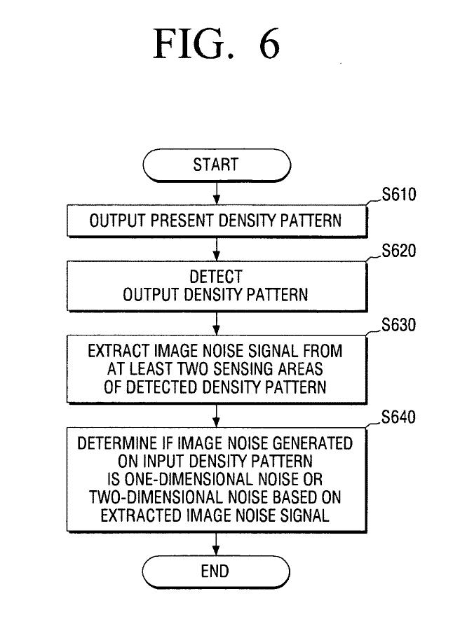

FIG. 6 illustrates a flow chart illustrating a method for processing image noise using an image forming apparatus according to an exemplary embodiment. Referring to FIG. 6, the output unit 110 outputs a density pattern (S610) and the input unit 120 detects the output density pattern (S620).

Subsequently, an image noise signal is extracted from at least two sensing areas of the detected density pattern (S630).

Based on the extracted image noise signal, it is determined if image noise generated on the detected density pattern is one-dimensional noise or two-dimensional noise (S640).

In addition, in this method, the image noise may be compensated according to the type of image noise determined by the control unit 140, and the display unit 150 may display the determination results.

Since the image noise can be distinguished as one-dimensional noise or two-dimensional noise, improved image quality can be evaluated objectively as well as improvement of image quality.

In a method for processing image noise using the image forming apparatus according to FIG. 5 is now described. Description overlapping with the description of FIG. 6 will be omitted. The printing engine unit 510 outputs a density pattern, and the scanning unit 520 scans the output density pattern.

Subsequently, the processor 530 extracts an image noise signal from at least two sensing areas of the scanned density pattern, and determines if the image noise generated on the density pattern is one-dimensional noise or two-dimensional noise based on the extracted image noise signal.

Finally, the display unit 540 displays the determination results.

Although a few example embodiments have been shown and described, the present disclosure is not limited to the described example embodiments. Instead, it would be appreciated by those skilled in the art that changes may be made to these example embodiments without departing from the principles and spirit of the disclosure, the scope of which is defined by the claims and their equivalents.

What is claimed is:

1. A method for processing image noise using an image forming apparatus, the method comprising:
outputting a density pattern;
detecting the output density pattern;
extracting an image noise signal from at least two sensing areas of the detected density pattern; and
determining if image noise generated on the detected density pattern is one-dimensional noise or two-dimensional noise based on the extracted image noise signal.

2. The method according to claim 1, wherein the determining comprises determining whether a correlation coefficient between the extracted image noise signals is greater than a predetermined threshold value.

3. The method according to claim 1, wherein in the determining comprises determining if multiplication between the extracted image noise signals is equal to a predetermined value.

4. The method according to claim 1, wherein the outputting comprises outputting onto a printing paper, and the detecting comprises scanning the printing paper.

5. The method according to claim 1, wherein the outputting comprises outputting onto an intermediate transfer belt (ITB), and the detecting comprises sensing the ITB.

6. The method according to claim 1, wherein the sensing areas comprise a sensing area in a horizontal direction and a sensing area in a vertical direction and the extracting comprises extracting the image noise signal at a particular position of each of the sensing area in the horizontal scanning direction and the sensing area in the vertical scanning direction.

7. The method according to claim 1, wherein the one-dimensional noise is banding and the two-dimensional noise is graininess or mottle.

8. The method according to claim 1, further comprising:
compensating the image noise according to the determined type of the image noise.

9. The method according to claim 1, further comprising:
outputting the results of the determining.

10. An image forming apparatus, comprising:
an output unit to output a density pattern;
a detector to detect the output density pattern;
a signal extraction unit to extract an image noise signal from at least two sensing areas of the detected density pattern; and
a control unit to determine if image noise generated on the detected density pattern is one-dimensional noise or two-dimensional noise based on the extracted image noise signal.

11. The image forming apparatus according to claim 10, wherein the control unit determines if the image noise generated on the detected density pattern is one-dimensional noise or two-dimensional noise by determining whether a correlation coefficient between the extracted image noise signals is greater than a predetermined threshold value.

12. The image forming apparatus according to claim 10, wherein the control unit determines if the image noise generated on the detected density pattern is one-dimensional noise or two-dimensional noise by determining if multiplication between the extracted image noise signals is equal to a predetermined value.

13. The image forming apparatus according to claim 10, wherein the density pattern is output onto a printing paper, and the detector scans the printing paper.

14. The image forming apparatus according to claim 10, wherein the density pattern is output onto an intermediate transfer belt (ITB), and the detector senses the ITB.

15. The image forming apparatus according to claim 10, wherein the sensing areas comprise a sensing area in a horizontal scanning direction and a sensing area in a vertical scanning direction and the signal extraction unit extracts the image noise signal at a particular position of the sensing area in the horizontal scanning direction and the vertical scanning direction.

16. The image forming apparatus according to claim 10, wherein the one-dimensional noise is banding and the two-dimensional noise is graininess or mottle.

17. The image forming apparatus according to claim 10, wherein the control unit compensates the image noise according to the determined type of the image noise.

18. The image forming apparatus according to claim 10, further comprising:
a display unit to display a result of the determination.

19. An image forming apparatus, comprising:
a printing engine unit to output a density pattern;
a scanning unit to scan the output density pattern;
a processor to extract an image noise signal from at least two sensing areas of the scanned density pattern, and determine if image noise generated on the scanned density pattern is one-dimensional noise or two-dimensional noise based on the extracted image noise signal; and
a display unit to display a result of the determination.

20. The method according to claim 1, further comprising determining whether the densities of the two sensing areas are the same, and the determining if the noise is one-dimensional noise or two-dimensional noise comprises determining one-dimensional noise if determined that the densities of the two sensing areas are the same, and determining two-dimensional noise if determined that the densities of the two sensing areas are not the same.

21. The image forming apparatus according to claim 10, wherein the control unit determines whether the densities of the two sensing areas are the same, and determines that the noise is one-dimensional noise if determined that the densities of the two sensing areas are the same, and determines that the noise is two-dimensional noise if determined that the densities of the two sensing areas are not the same.
